(19) United States
(12) Patent Application Publication
(10) Pub. No.: US 2006/0103365 A1
(43) Pub. Date: May 18, 2006

(54) Method and converter circuitry for improved-performance AC chopper

(75) Inventor: Shmuel Ben-Yaacov, Beer-Sheva (IL)

Correspondence Address: DR MARK FRIEDMAN LTD.;c/o Bill Polkinghorn, 9003 Florin Way, Upper Marlboro, MD, 20772, US

(73) Assignee: COMPULITE SYSTEMS (2000) LTD.

(21) Appl. No.: 10/989,337

(22) Filed: Nov. 17, 2004

(51) Int. Cl. G05F 3/16

(52) U.S. Cl. 323/313

(57) ABSTRACT

A system and method for single phase AC power conversion for delivery to a load of AC voltage less than or equal to the supply voltage. The system includes a high frequency chopper converter having a series diode-switch assembly and a shunt diode-switch assembly. During intervals when the inductor carries current in phase with the power line, the diode-switch assemblies are configured such that the system operates as a buck converter, and during intervals when the inductor carries current out of phase with the power line, and power flow is reversed, the diode-switch assemblies are configured such that the system operates as a boost converter, boosting the load voltage to the power line voltage. Optionally, feedback is used to adjust the duty cycles of the diode-switch assemblies to shape the input and/or output current and to optimize performance of the load.

### FIELD AND BACKGROUND OF THE INVENTION

The present invention relates to a switching power converter and, more particularly, to a method and circuitry for converting an alternating-current (AC) power line voltage into a lower AC voltage while drawing from the line a current of proportionally lower amplitude.

The prior art includes several types of converters, which are widely used for DC(direct current)-to-DC, DC-to-AC, AC-to-DC and AC-to-AC power conversion. In some applications the purpose of the converter is to provide a regulated output voltage. In other applications, the purpose of the power conversion schemes is attenuating the voltage of an AC source, such as a power line, while maintaining the waveform of the line voltage. For example, in a power converter known in the art as an AC Chopper, the role of the converter is to supply to a load an AC voltage lower than the voltage of the AC source. This is accomplished by introducing an AC (bidirectional) switch between the line and load and operating the switch at a given duty cycle, D, where D is the fraction of the time that the switch is in a conductive, or “on” state. Such a chopper feeds the load ‘slices’ of the source voltage, resulting in a lower average power delivered to the load, relative to the load power when the load is connected directly to the source. If the chopping is carried out at high frequency, as compared to the frequency of the source (typically, the chopping frequency is above 10 kHz in 50 Hz or 60 Hz power line applications), and a filter is introduced between the AC switch and the load, then the waveform of the voltage applied to the load substantially resembles the waveform of the source voltage, although attenuated. The output voltage is then substantially equal to the input voltage times the duty cycle, D (neglecting losses in the converter).

If the load is linear, the load current is equal to the load voltage divided by the impedance of the load. This current, drawn from the source, is chopped by the AC switch of the chopper. Consequently the source current is the output current times the duty cycle, D and, with appropriate filtering to remove high-frequency components, the waveform of the source current substantially resembles the waveform of the load current, although attenuated. If the load is linear and the source voltage is sinusoidal then the source current is also substantially sinusoidal, i.e., of small harmonic content and with low harmonic distortion. This is of special practical importance considering the harmful effects that high levels of current harmonics have on power lines. Among these harmful effects are reduced efficiency of power transmission, possible interference to other devices connected to the power line and distortion of the waveform of the line voltage. In light of these harmful effects, many regulatory authorities have adopted, or are in the process of adopting, voluntary and mandatory standards and statutes which set limits on permissible line current harmonics injected by any given electrical equipment powered by the AC mains, in order to maintain relatively high quality of power.

Considering the above, AC choppers are good solutions for cases in which there is a need to control the AC power of a linear load while maintaining a sinusoidal line current, that is, of low harmonic content. Incandescent lamp dimmers fall into this application category. For any given power level, an incandescent lamp practically represents a resistive load and hence, when driven by an AC chopper, draws from the power line a substantially sinusoidal current. AC choppers are therefore a preferred approach for realizing incandescent lamp dimmers. An earlier approach to dimmer design that was based on phase control, i.e. a low frequency chopper typically realized with SCR (Silicon Controlled Rectifier, or Thyristor) switches, has many deficiencies, including the fact that it injects a very high level of current harmonics into the line. Among the disadvantages of the low-frequency chopper are the mechanical stress on lamp filaments when fed by low-frequency high-current pulses, and high peak current in the line that may blow fuses or trip circuit breakers. It is thus evident that the high-frequency chopper is a preferred design solution for line-fed controlled-voltage AC sources in general, and for incandescent lamp dimmers in particular.

Practical design of high-frequency (HF) AC choppers requires the incorporation of an additional switch, aside from the series chopping AC switch. This is because the output filter typically includes a series inductor, and when the current through the inductor is interrupted when the serially connected AC switch is turned off an alternative conduction path must be provided for the current. Otherwise, very large and damaging voltage spikes develop. Many solutions have been proposed in the past to overcome this problem. Among these solutions is the incorporation of another AC switch between the input terminals of the output filter, i.e., connected as a shunt, in the manner of the connection in FIG. 1 of switch 4a. This second, shunt, AC switch operates in a manner complementary to the first, series, AC switch. That is, when one switch is conducting, the other switch is cut off. By this mechanism the second AC switch provides a path for the filter inductor current when the series AC switch is in the non-conducting state. U.S. Pat. No. 5,500,575 and Nabil A. Ahmed, Kenji Amei, and Masaaki Sakui, A New Configuration of Single-Phase Symmetrical PWM, AC Chopper Voltage Controller, IEEE Transactions on Industrial Electronics, Volume 46, Issue 5, pp. 942-952, October 1999, which are incorporated by reference for all purposes as if fully set forth herein, teach a modified solution wherein the second switch, placed across the input terminals of the filter, includes a combination of diodes and switches to provide the necessary conductive path for the current of the inductor of the output filter when the series AC switch is in the ‘off’ state.

However, prior-art HF AC chopper systems, such as the teaching of U.S. Pat. No. 5,500,575 and other publications, suffer from a basic problem that leads to the generation of high-voltage spikes and power losses, and hence, lower efficiency. The problem stems from the need to leave a “deadtime” during which neither the series AC switch nor the AC switch (or diode-switch assembly) connected at the input terminals of the output filter are conductive. This is necessary to avoid a so-called “overlap” or “shoot-through” situation in which the input source is shorted by the two conductive switches that are effectively serially connected across the source. During this deadtime the current of the output filter inductor is interrupted and a potentially damaging high-voltage spike develops. This voltage might exceed the breakdown voltages of the active and passive elements of the circuit and cause irreversible damage to the system. To overcome this problem, Ahmed et al. teaches the placement of a capacitor at the input to the output filter. This “snubber” capacitor provides a path for the filter inductor current, and, if large enough, prevents the development of large voltage spikes. However, this capacitor causes large current spikes and losses in the series AC switch. This happens when the switch is turned on and is effectively connecting the AC source to the capacitor. The voltage difference between the input voltage and the capacitor voltage causes high charging current, limited only by the parasitic resistances of the line and switch.

It is thus evident that the prior art has failed to provide a remedy for the problem of the deadtime in HF AC choppers.

Because the issue of current harmonic injection to the power line is of great importance, as is evident from the standards that are enforced by many regulatory authorities, close control of the input current waveform is a desirable feature of an AC chopper. Prior art teachings do not adequately address this issue but, rather, assume that when the HF AC chopper operates in “open loop” (with respect to the input current), the input current is automatically of low harmonic content. This is correct if two conditions are fulfilled: first, that the load is linear and, second, that the input filter and the output filter both operate with the inductor current in Continuous Conduction Mode (CCM). That is, that the currents in the filters never reach zero. As is very well known in the art, any filter leaves the CCM and enters the Discontinuous Conduction Mode (DCM) if the load resistance is increased sufficiently. The boundary between CCM and DCM depends upon the value of the inductance of the filters. Thus, any HF AC chopper tends to enter DCM for low-power loads. This causes a distortion of the input current and prior-art solutions fail to provide a remedy for this problem, too.

In some applications, the waveform of the output voltage is an important consideration. For example, because harmonics are known to cause losses in motors, it is desirable to feed motors with a pure sinusoidal waveform. However, in prior art solutions the waveform of the output voltage is a replica of the waveform of the input voltage. Thus, if the input voltage waveform is distorted, the output waveform also is distorted.

It is thus evident that prior-art teachings fail to provide solutions to many problems associated with the design of a HF AC chopper.

Therefore, it is desirable to have a HF AC chopper, for incandescent lamp dimmers and other applications, in which the deadtime is eliminated, thus avoiding the problem of high-voltage spikes and the need for snubber capacitors, both of which cause electrical noise and power losses.

It is further desirable that a HF AC chopper be able to feed not only resistive loads but reactive loads as well, in which there is a phase difference between the load voltage and the load current and energy is fed back to the source during part of the cycle, while still operating the chopper without a deadtime interval.

It is also desirable for the HF AC chopper to include inrush-current control and over-current protection to increase the robustness and reliability of the chopper and protect devices connected to the chopper.

It is also desirable that a HF AC chopper be able to operate in closed-loop configurations for cases that require precise control of the output voltage.

It is further desirable that a HF AC chopper be able to operate in closed-loop configurations for cases that require precise control of the input current.

It is further desirable that a HF AC chopper be able to operate in closed-loop configurations for loads that require precise control of output current, such as discharge lamps and certain types of motors.

There is thus a widely recognized need for, and it would be highly advantageous to have, an economical, rugged, robust and compact AC chopper capable of handling reactive loads efficiently and drawing from the power line a current having minimal harmonic content, without a need for deadtime, without a need for snubber components associated with the chopping switches, and capable of including such features as inrush-current control, over-current protection, and closed-loop control of output voltage, input current, or output current, including when the chopper filters operate in DCM.

### DEFINITIONS

As used herein, unless otherwise specified, the term “valve” refers to a device for controlling electric current. Valves may include, but are not limited to, vacuum tubes, gas-filled tubes, vapor-filled tubes, diodes, switches, Insulated-Gate Bipolar Transistors (IGBT), Metal-Oxide Semiconductor Field-Effect Transistors (MOSFET) and Bipolar Junction Transistors (BJT) and combinations thereof. Valves may serve functions including, but not limited to, rectification, switching, and amplification. The particular type of valve intended is clear from context. Although this usage of the term “valve” is inspired by the British usage of that term to describe vacuum tubes, the usage here is, per the above definition, different and broader.

As used herein, unless otherwise specified, the term “power line” refers to a source of electrical power, including, but not limited to, commercial power mains, generators, inverters, and power systems on board automobiles, trucks, ships, submarines, aircraft, spacecraft, and other vehicles.

As used herein, unless otherwise specified, a waveform of a parameter is a set of values of that parameter as a function of time. Parameters that may have waveforms include, but are not limited to, voltage and current.

As used herein, unless otherwise specified, a voltage and current are said to be “in phase” when the current is flowing in the direction that current would flow when the voltage is loaded by a resistor.

As used herein, unless otherwise specified, a voltage and current are said to be “out of phase” when the current is flowing in a direction opposite to the direction that current would flow when the voltage is loaded by a resistor. Examples of out of phase currents include the charging of a battery and the return of energy to an AC power line by a reactive load during a portion of the AC cycle.

### SUMMARY OF THE INVENTION

It is an object of the present invention to provide HF AC chopper circuitry that does not rely on deadtime and always provides a current path for the current of the inductor of the output filter, simplifying construction and increasing the reliability, efficiency and flexibility of the chopper for a variety of applications including lamp dimming and motor control.

It is another object of the present invention to eliminate the need for snubber capacitors in HF AC choppers to avoid large charging currents.

It is yet another object of the present invention to provide economical digital circuitry for improving the performance and ruggedness of HF AC choppers.

It is yet another objective of the present invention to provide HF AC chopper circuitry that integrates other functions within the chopper, such as inrush-current control, over-current protection and output-voltage control to increase the reliability, economy and range of application of AC choppers.

It is also an object of the present invention to provide a HF AC chopper that provides tight control of the input current even if the filters of the chopper enter DCM.

It is yet another object of the present invention to provide a HF AC chopper that provides tight control of the output voltage even if the filters of the chopper enter DCM.

The present invention is directed to a method for converting the voltage of an AC source into a voltage of lower amplitude of the same waveform as the input voltage.

It is common practice for single-phase AC power lines to include a phase conductor and a neutral conductor. The neutral conductor is substantially at ground potential, while the potential of the phase conductor varies sinusoidally with respect to the potential of the neutral conductor. The phase conductor can be referred to by such terms as “hot”, “high”, or, simply, “phase” and the neutral conductor can be referred to by such terms as “low”, or, simply, “neutral”. The present invention is described herein with respect to this type of power line. However, other types of single-phase power lines, including power lines wherein both conductors are permitted to “float” with respect to ground potential, are possible. It will be readily apparent to those skilled in the art that the present invention is also applicable to such other types of power lines, and the use of such other types of power lines is within the scope of the present invention.

The present invention accomplishes voltage reduction by turning on and off a set of switches which connect an input terminal of an output filter inductor alternately to the phase conductor or to the neutral conductor of the input source, either directly or via diodes. The present invention makes optimal use of diode-switch combinations such that a conductive path is always provided for the inductor current, either to the phase side or to the neutral side of the input power line while, at the same time, avoiding a short circuit across the input power line. The present invention controls the output voltage of the AC chopper by a including a combination of analog circuitry and digital circuitry that drives the diode-switch assemblies in a manner that maintains the desired output voltage by duty-cycle control. The present invention also provides output voltage control that can generate a substantially pure sinusoidal output voltage even if the input voltage waveform is distorted. Furthermore, the present invention includes other important features, such as over-current protection and inrush-current control without adding considerable complexity and/or cost to the controller circuitry, while providing, at all times, a path for the output filter inductor current, thus avoiding dangerous voltage spikes.

Accordingly, the present invention is characterized by providing an inherent voltage clamp that operates as a lossless snubber.

The present invention discloses a HF AC chopper apparatus which has improved reliability, higher efficiency, and programmability features, the chopper including at least an output filter inductor and two controllable diode-switch assemblies, one diode-switch assembly connected between the phase side of the input source and the input terminal of the output filter inductor, and the other diode-switch assembly connected between the same inductor terminal and the neutral side of the input source.

Preferably, a switching power converter according to the present invention also includes:

inductor-current sampling circuitry, for sampling the instantaneous value of the main inductor current;

voltage sampling circuitry, for sampling the instantaneous polarity of the input voltage; and

a combination of analog circuitry and digital circuitry that is supplied with a reference signal, a signal indicative of the polarity of the inductor current, and a signal indicative of the polarity of the input voltage, the circuitry operative to control the switching of the diode-switch assemblies and thereby, to cause the output voltage of the AC chopper to follow the shape on the input voltage with a magnitude that is proportional to the reference signal, but limit the output current during inrush and overload conditions.

Optionally, the above-mentioned analog and digital circuitry is supplied with a signal proportional to the inductor current and a signal proportional to the input voltage. The use of signals merely indicating the polarities of the inductor current and the input voltage is sufficient for open-loop operation. The use a signal proportional to the inductor current or a signal proportional to the input voltage, or both, is preferable for closed-loop operation.

The combination of analog circuitry and digital circuitry preferably further includes:

Comparators operative to produce binary output signals indicating the polarity of the input voltage and the polarity of the inductor current, and an over-current signal that is active when the inductor current exceeds a predetermined level;

a time-base for determining the switching period;

a pulse width modulator (PWM) for controlling the duty cycle; and

logic circuitry to process the above-mentioned signals and produce drive signals for the switches.

According to the present invention there is provided a power converter system connecting an AC power line to a load, including: (a) a series valve in series with the load; (b) a shunt valve in parallel with the load; (c) an inductor in series with the load; and (d) a mechanism for configuring the valves so that the power converter operates as a buck converter while the inductor carries current in phase with the power line and as a boost converter while the inductor carries current out of phase with the power line.

Preferably, in the system, the mechanism includes: (i) a control signal, and the mechanism is operative to operate a valve according to a duty cycle ratio selected so as to cause a voltage across the load to be substantially in proportion to the control signal.

Alternatively, in the system, the mechanism includes: (i) a control signal; and (ii) a feedback sensor, and the feedback sensor is operative to sense, for use as a feedback signal, a parameter of the system, and the mechanism is operative to compare the feedback signal with the control signal and to operate a valve according to a duty cycle ratio selected so as to cause the feedback signal to be in proportion to the control signal.

Preferably, in the alternative system, the feedback signal is selected from the group consisting of an output voltage, an output current, an input current, an inductor current, a load power dissipation, a load temperature, a position, a speed, an acceleration, a force, a torque and a light intensity.

Preferably, the system further includes: (e) a mechanism for sensing an output current, and a valve is operated according to a duty cycle ratio selected so as to restrict the output current to be within a predetermined limit profile.

Preferably, the system includes: (e) a mechanism for sensing an output current, and, if the output current exceeds a predetermined limit profile, the valves are operated in a manner selected to interrupt the output current while providing a path for dissipation of a current flowing through the inductor.

Preferably, in the system, at least one valve includes a diode-switch assembly.

Preferably, in the system, at least one diode-switch assembly includes: (i) a first diode; (ii) a second diode; (iii) a first switch; and (iv) a second switch, and the first diode is serially connected to the second diode such that the first diode permits flow of current in a direction opposed by the second diode, and wherein the first switch is responsive to a first switch control signal and is connected in parallel with the first diode, and wherein the second switch is responsive to a second switch control signal and is connected in parallel with the first diode.

Alternatively, in the system, at least one diode-switch assembly includes: (i) a first diode; (ii) a second diode; (iii) a first switch; and (iv) a second switch, and the first diode is serially connected to the first switch, the first switch being responsive to a first switch control signal, and wherein the second diode is serially connected to the second switch, the second switch being responsive to a second switch control signal, the serially connected first diode and first switch being connected in parallel with the serially connected second diode and second switch, such that the first diode permits flow of current in a direction opposite to a direction the second diode permits flow of current.

Preferably, in the system, the mechanism includes: (i) a sawtooth waveform generator; (ii) a control signal; and (iii) a comparator, and the comparator is operative to compare an output of the sawtooth waveform generator with the control signal and to produce an output signal having a duty cycle ratio substantially in proportion to the control signal and operative to control a valve.

Preferably, in the system, the mechanism is operative, upon change of polarity of a power line voltage, to operate the valves in a manner that prevents shorting of the power line and provides a conductive path for current in the inductor.

Preferably, in the system, the mechanism is operative, upon change of polarity of current in the inductor, to operate the valves in a manner that prevents shorting of the power line and provides a conductive path for current in the inductor.

Preferably, the system is connected to the power line via a filter.

According to the present invention there is provided a method of supplying power from an AC power line to a load, including the steps of: (a) connecting a series valve in series with the load; (b) connecting a shunt valve in parallel with the load; (c) connecting an inductor in series with the load; (d) while the inductor carries current in phase with the power line, configuring the valves to operate as a buck converter; and (e) while the inductor carries current out of phase with the power line, configuring the valves to operate as a boost converter.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 illustrates schematically major components of a HF AC chopper power stage according to prior art;

FIG. 1a illustrates schematically major components of a HF AC chopper power stage according to the present invention;

FIG. 2 illustrates schematically voltage and current waveforms for an inductive load;

FIG. 3 illustrates schematically the various configurations of diodes and switches of a HF AC chopper power stage according to the present invention corresponding to the various operational regimes of the chopper;

FIG. 4 illustrates schematically an optional embodiment of a HF AC chopper according to the present invention;

FIG. 5 illustrates schematically the various configurations of switches of the power stage of the HF AC chopper of FIG. 4 corresponding to the various operational regimes of the chopper;

FIG. 6 illustrates schematically an alternative set of configurations of switches of the power stage of the HF AC chopper of FIG. 4 corresponding to the various operational regimes of the chopper;

FIG. 7 illustrates schematically the transition between the operational regimes illustrated in FIG. 6a and FIG. 6b;

FIG. 8 illustrates schematically an embodiment of a HF AC chopper according to the present invention;

FIG. 9 (prior art) illustrates schematically an alternative configuration of a diode-switch assembly.

### DESCRIPTION OF THE PREFERRED EMBODIMENTS

The present invention is of a HF AC chopper which can be used to control delivery of power to a load. Specifically, the present invention can be used to provide an AC voltage that is less than the powerline voltage and is of substantially sinusoidal waveform to a load. The load can be resistive or reactive, and the current drawn from the power line is substantially sinusoidal and has minimal harmonic content.

The principles and operation of a HF AC chopper according to the present invention may be better understood with reference to the drawings and the accompanying description.

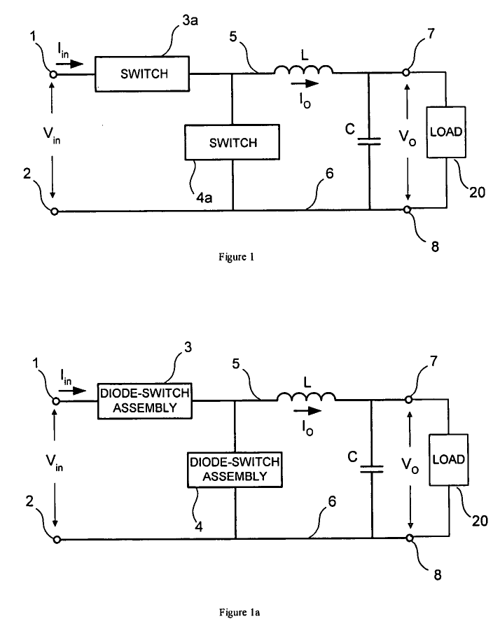

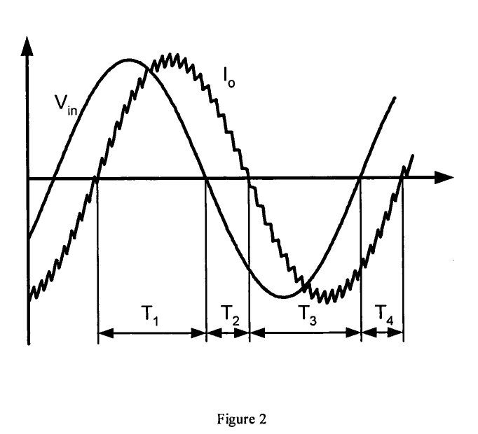

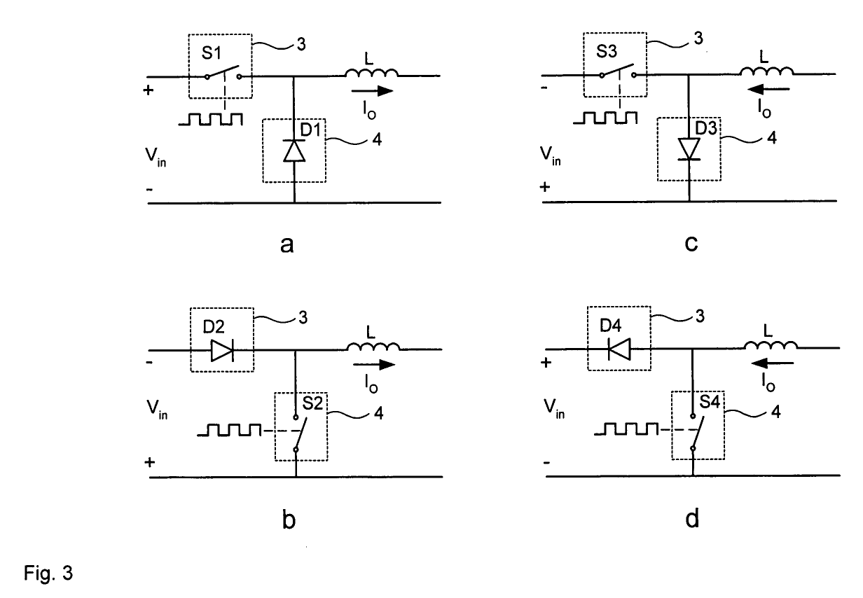

Referring now to the drawings, FIG. 1a illustrates a generic embodiment of the power stage of a HF AC chopper according to the present invention. FIG. 2 illustrates schematically voltage and current waveforms associated with the chopper. FIG. 3 illustrates, schematically, operational modes, or regimes, corresponding to portions of the waveforms depicted in FIG. 2. The power stage depicted in FIG. 1a includes input terminals 1 and 2 to which an input AC source, having an AC potential Vᵢₙ, is connected, output terminals 7 and 8, to which a load 20 is connected, and across which an output voltage V₀ appears, two diode-switch assemblies 3 and 4, and an output filter that includes at least an inductor L in series with load 20 and optionally includes a capacitor C placed across output terminals 7 and 8. Diode-switch assembly 3 is connected between input terminal 1 and the input terminal 5 of the output filter, whereas diode-switch assembly 4 is connected across input terminals 5 and 6 of the output filter. HF AC chopping is achieved by controlling the conduction of diode-switch assemblies 3 and 4 with a duty cycle ratio D, where D is the ratio of the time diode-switch assembly 3 is conductive to the total time of a switching cycle, D thus having a range from zero to one, operating at a switching frequency higher than the frequency of the input AC source, such that the voltage across the input terminals 5 and 6 of the output filter is “slices” of the input voltage. Hence, after suppression of the high frequency components by the output filter, voltage waveform V₀ at output terminals 7 and 8 is substantially a replica of the input voltage waveform, multiplied by duty cycle ratio D.

When load 20 has a reactive impedance, current through output terminals 7 and 8, and therefore current I₀ through inductor L, is of different phase with respect to output voltage V₀. For example, in a case of a linear inductive load 20, current I₀ lags voltage V₀ as shown schematically in FIG. 2. The illustrated current waveform includes a HF ripple due to the fact that a chopped voltage is fed to the output filter. The phase delay between input voltage Vᵢₙ and current I₀, through inductor L creates four distinctive time intervals, or regimes, designated in FIG. 2 as T₁, T₂, T₃ and T₄. T₁ designates a time interval when input voltage Vᵢₙ and inductor current I₀ are both positive, T₂ designates a time interval when input voltage Vᵢₙ is negative and inductor current I₀ is positive, T₃ designates a time interval when both input voltage Vᵢₙ and inductor current I₀ are negative, and T₄ designates a time interval when input voltage Vᵢₙ is positive and output current I₀ is negative. It should be noted that during time intervals T₁ and T₃ power is delivered from the source to load 20, whereas during time intervals T₂ and T₄ power is fed back to the source from load 20.

To accommodate all possible combinations of voltage and current polarity, and hence, power flow in either direction, to avoid the need for a deadtime during which inductor current I₀ is interrupted, and to avoid a short circuit across input terminals 1 and 2, the present invention utilizes diode-switch assemblies to provide safe current paths at all times. This is accomplished by first, always providing a current path via a diode or a switch, and second, blocking the possibility of a short circuit across input terminals 1 and 2 by placing diodes in series with switches such that either the diode or the switch conducts. Accordingly, each diode-switch assembly includes diodes and switches that are activated during specific time intervals. The operation of these devices according to the present invention is further detailed below with reference to FIG. 3 which shows schematically the basic diode and switch configurations during the four time intervals T₁, T₂, T₃ and T₄.

FIG. 3a illustrates schematically operation of a HF AC chopper according to the present invention during interval T₁. During T₁ input voltage Vᵢₙ is positive and the direction of current I₀ is toward load 20. Therefore, power is delivered from the source to load 20. In this case, according to the present invention, series diode-switch assembly 3 is configured to act as an active chopper switch, S1, and shunt diode-switch assembly 4 is configured to serve as a freewheeling diode, D1. This configuration is known in the art as a “Buck” or “Step-Down” converter. During T₁, output voltage V₀ is substantially equal to input voltage Vᵢₙ multiplied by duty cycle ratio D.

Preferably, a diode incorporated in a diode-switch assembly of a HF AC chopper according to the present invention has a short forward recovery time to prevent excessive voltage across any valve or valves that are in substantially non-conductive states at times when the diode is beginning to conduct.

FIG. 3b illustrates schematically the operation of a HF AC chopper according to the present invention during interval T₂. During T₂ input voltage Vᵢₙ is negative, while current I₀ flows toward load 20. Therefore, power flows back to the source. In this case, according to the present invention, shunt diode-switch assembly 4 is configured to act as an active chopper switch, S2, and series diode-switch assembly 3 is configured to serve as a freewheeling diode, D2. This configuration is known in the art as a “Boost” or “Step-Up” converter. In this case load 20 is considered to be the power source while the AC power line is in fact the power load of the boost converter. Under these conditions the voltage across load 20 is substantially equal to the input voltage times D'_{Boost}, where D'_{Boost}=1−D_{Boost}, and D_{Boost} is the duty cycle ratio of switch S2. Hence, to maintain the same transfer ratio as during time interval T₁, D_{Boost} must be substantially equal to 1-D, where D is the duty cycle ratio that is used during T₁.

According to the present invention, during T₃, which is similar to T₁, except that the directions of the voltages and currents are reversed, series diode-switch assembly 3 is configured to act as an active chopper switch, S3, and shunt diode-switch assembly 4 is configured to serve as a freewheeling diode, D3, as illustrated schematically in FIG. 3c. This is again a buck configuration and power flows from the source to load 20. Hence S3 is operated with duty cycle ratio D.

Time interval T₄ is similar to T₂ in that power flows back to the source. In this case, illustrated schematically in FIG. 3d, shunt diode-switch assembly 4 is configured as an active chopper switch, S4, and series diode-switch assembly 3 is configured to serve as a freewheeling diode, D4. In this case, S4 operates with a duty cycle ratio of 1-D.

The operation illustrated schematically in FIG. 3 clearly shows that an HF AC chopper according to the present invention fulfills the above-mentioned objectives of having no deadtime and never shorting the input. Although the above example refers to a case of a lagging current (inductive load), it will be readily apparent to those skilled in the art that the method of diode and switch arrangement according to this invention can be applied to accommodate a leading current as is the case with a capacitive load. In fact, the instantaneous polarity of input voltage Vᵢₙ and the instantaneous polarity of inductor current I₀ determine, unequivocally, the required diode and switch arrangements for any one of the four operational regimes for effective and safe operation.

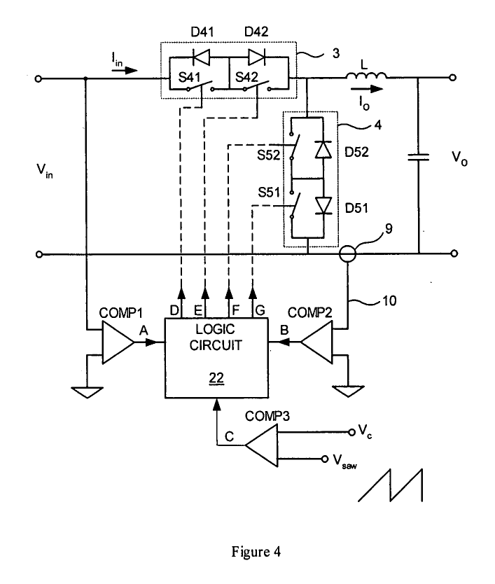

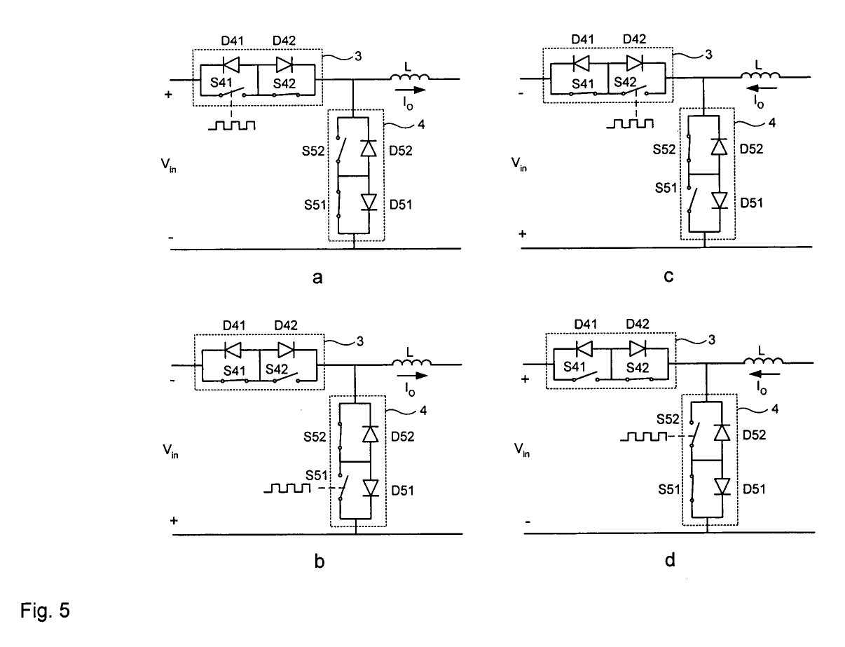

FIG. 4 illustrates, schematically, in more detail, a preferred embodiment of the present invention. In this case series diode-switch assembly 3 includes two serially connected switches, S41 and S42, each paralleled by a corresponding diode, D41 and D42, respectively, and shunt diode-switch assembly 4 includes two serially connected switches, S51 and S52, each paralleled by a corresponding diode, D51 and D52, respectively. This embodiment includes a comparator, COMP1, to which input voltage, Vᵢₙ, or a fraction thereof, is fed, with the reference input of COMP1 connected to the neutral line, such that the output of COMP1, on line A, is in one state when input voltage Vᵢₙ is positive, and in a second state when input voltage Vᵢₙ is negative. Also shown in FIG. 4 is an output current sensor 9 operative to impress upon line 10 a voltage proportional to current I₀. This voltage is fed to a second comparator, COMP2, operative to impress a two-state signal on line B, one state corresponding to output current I₀ having a positive value, i.e., flowing in the direction of the arrow, and the other state corresponding to output current I₀ having a negative value, i.e., flowing opposite the direction of the arrow. A third comparator, COMP3, is operative to produce a PWM signal. This is accomplished by feeding a saw-tooth waveform V_{saw} to one input of COMP3, and a control signal, V_{c}, to a second input of COMP3. As is well know in the art, the output of COMP3, on line C, is a PWM signal having a duty cycle ratio proportional to V_{c}. The signals on lines A, B and C are fed to a logic circuit 22 operative to impress upon respective lines D, E, F and G corresponding control signals for corresponding switches S41, S42, S51 and S52. Logic circuit 22 can be implemented in a variety of ways, including, but not limited to, a set of gates, either hard-wired or programmable, operative to realize respective Boolean functions corresponding to the operation of corresponding switches S41, S42, S51 and S52 during time intervals T₁, T₂, T₃ and T₄, as well as the transitional states. Any logic circuit arrangement producing the required Boolean functions is included within the scope of the present invention. Optionally, logic circuit 22 includes a memory operative to assist in recognition of transitions between regimes. Switch arrangements, according to this embodiment, during the four regimes, are illustrated schematically in FIG. 5. FIG. 5a corresponds to switch operation during T₁, FIG. 5b corresponds to switch operation during T₂, FIG. 5c corresponds to switch operation during T₃, and FIG. 5d corresponds to switch operation during T₄. Considering, for example, regime T₄, in FIG. 5d, and assuming that each respective switch S41, S42, S51 or S52 is conductive, or on, when a corresponding control input to the switch is in a high logic state, and non-conductive, or off, when a corresponding control input to the switch is in a low logic state, it is required that logic circuit 22 produce a low state on line D, forcing S41 to the off state, a high state on line E, forcing S42 to the on state, the inverter PWM signal on line F, thus operating switch S52 in the chopping mode, and a high state on line G, forcing S51 to the on state.

According to the present invention, switch operation is not limited to the sequence shown in FIG. 5, but can be achieved in alternative ways. For example,

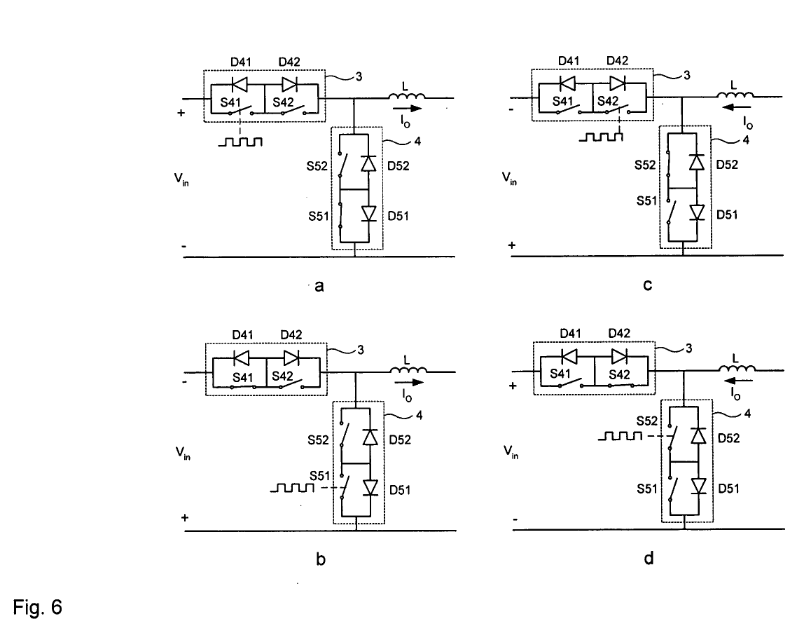

FIG. 6 shows a switch operation sequence in which the chopping element consists of a diode and a switch in series. This is the situation when the switches are implemented as IGBT devices which are unidirectional, that is, current can flow in one direction only, from collector to emitter. Hence, in FIG. 5a current does not flow through S42 if S42 is implemented as an IGBT. Consequently, S42 can be considered non-conducting, as shown in FIG. 6a. Similarly, the states of FIGS. 5b, 5c and 5d can be translated into the states of FIGS. 6b, 6c and 6d. The operation of a HF AC chopper according to the switch states shown in FIG. 6 provides chopping and current paths per the stated objectives of the present invention.

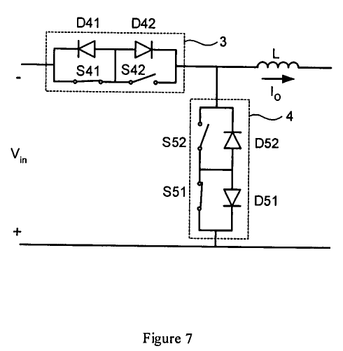

As will be readily apparent to those skilled in the art, generation of switch control signals according to the present invention is easily accomplished by use of devices including, but not limited to, dedicated logic circuitry, programmable logic circuitry including, but not limited to, a Field Programmable Gate Array (FPGA), or a microprocessor. Furthermore, as will be readily apparent to those skilled in the art, the transition from one diode-switch operational regime to another is done while fulfilling the above-stated objectives, i.e., keeping at all times an open path for the inductor current and avoiding a short circuit across input terminals 1 and 2. This is illustrated schematically in FIG. 7, which depicts the states of diode-switch assemblies 3 and 4 during a transition between interval T₁, illustrated schematically in FIG. 6a, and interval T₂, illustrated schematically in FIG. 6b. This transition occurs when input voltage Vᵢₙ changes polarity while the direction of output current I₀ remains from terminal 5 to toward terminal 7. In FIG. 6a, corresponding to interval T₁, S41 is chopping and S42 is off. During the transition from interval T₁ to interval T₂ (see FIG. 7), which lasts an amount of time on the order of a single chopping cycle, S41 stops chopping and switches to the on state, and S51 remains on. During this transitional state, diode D42 prevents shorting of the power line, and switch S51, together with diode D52, provides a path for current I₀. After the transition, during interval T₂, as illustrated schematically in FIG. 6b, S41 is left on and S51 chops state. It will be readily apparent to those skilled in the art that the objectives of no deadtime and no short circuiting of the power line are met during intervals T₁ and T₂ as well as during the transition from one interval to another. Transitions between other intervals are dealt with in a similar manner, as will be readily apparent to those skilled in the art.

It will be readily apparent to those skilled in the art that the chopping frequency need not necessarily be constant, and that the duty cycle ratio also need not necessarily be constant within any particular interval, and that allowing the chopping frequency and duty cycle ratio to vary in a controlled fashion provides opportunities to control the output of a HF AC chopper according to the present invention in a flexible manner. Several variations of the present invention that take advantage of this flexibility are described below, and such variations, including, but not limited to those described herein, are within the scope of the present invention.

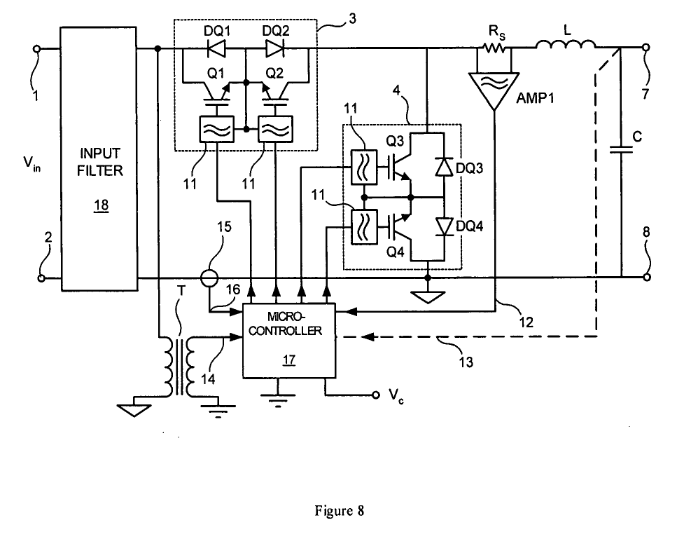

Another possible embodiment of a HF AC chopper according to the present invention is illustrated schematically in FIG. 8. In this case, respective IGBT power switches Q1, Q2, Q3 and Q4, with corresponding antiparallel diodes D1, D2, D3 and D4, are the basic switching elements, implementing diode-switch assemblies 3 and 4. Output current I₀ is sensed by an isolated amplifier AMP1 having differential inputs placed across a sense resistor Rₛ. The output signal of AMP1 on line 12 is fed to a microcontroller 17. Isolation transformer T produces a signal on line 14 that is proportional to input voltage Vᵢₙ, and this signal on line 14 is also fed to microcontroller 17. This embodiment also includes an input filter 18 operative to attenuate HF components of the current drawn from the power line. Microcontroller 17 also receives control signal V_{c}, operative to set output voltage V₀. Output voltage control is accomplished by software running on microcontroller 17 operative to set the duty cycle ratio according to the magnitude of control signal V_{c}.

An important feature of a HF AC chopper according to the present invention is the ability to protect the circuitry against high current, as might develop if the output is shorted, or as a result of inrush current. Inrush current develops in various loads in response to a fast increase in output voltage. For example, in incandescent lamp dimmer applications, inrush current develops when the lamp filaments are cold until the filaments reach the elevated operating temperature. This is because of the large difference in the resistance of a filament when the filament is cold and when the filament is hot. Under typical operating conditions, the resistance of a hot filament is typically more than 10 times the resistance of a cold filament. Consequently, when a voltage is first fed to an incandescent lamp, the current is much greater than the nominal operating current. This might cause interference on the power line feeding the lamp and could harm the HF AC chopper. Similarly, a short circuit causes high currents to build up and, unless controlled, damages the HF AC chopper. In the case of high current buildup, a deadtime could be especially harmful because interruption of the high current generates very large voltage spikes that can easily cause breakdown. The present invention solves the protection problem by first limiting the duty cycle ratio to lower the output voltage and, if required, bringing the duty cycle ratio down to zero, while always providing a conduction path for the inductor current I₀. This is accomplished inexpensively via a software routine in the case of a microcontroller-based system, or by additional logic circuitry in the case of an analog-digital implementation.

The current is limited according to a limit profile, which allows flexibility in the limitation of overcurrents. In one class of embodiments of the present invention, such a profile allows large overcurrents for very short periods, moderate overcurrents for longer periods, and small overcurrents for even longer periods, in a manner similar to a “slow-blow” fuse or circuit breaker. In the simplest case, a limit profile includes a single overcurrent setting. All such limit profiles are within the scope of the present invention.

Returning to FIG. 8, a line 13 optionally is used as a feedback signal from output voltage V₀. This can be used to run a HF AC chopper in a closed loop configuration. Closed loop operation is achieved by comparing the momentary value of output voltage V₀ to input voltage Vᵢₙ and adjusting the duty cycle ratio such that the output voltage waveform follows the input voltage waveform while keeping the amplitude of the output voltage V₀ at a level determined by control signal V_{c}.

In another mode of operation according to the present invention, an output feedback path is used to control the waveform of output voltage V₀ such that output voltage V₀ has a waveform different from the waveform of input voltage Vᵢₙ, provided that the target for output voltage V₀, at any given time, is lower than the input voltage Vᵢₙ at that time. In this case control signal V_{c} is not used only to designate an attenuation level, but rather as a reference that varies with time. For example, V_{c} can be a pure sinusoidal reference voltage and the feedback arrangement forces output voltage V₀ to follow that reference voltage even if input voltage Vᵢₙ has a distorted waveform. Similarly, it is possible to use output current I₀ as a feedback variable, in which case the HF AC chopper acts as a current source, which is desirable for loads for which it is preferable to control current, rather than voltage. Such loads include, but are not limited to, discharge lamps, light emitting diodes, lasers, and arc welders.

Optionally, an additional current sensor 16 is used to tightly control the input current Iᵢₙ so as to either follow input voltage Vᵢₙ, or to have of a pure sinusoidal waveform. This is important in cases where the load is non-linear and, hence, causes input current Iᵢₙ to be distorted. This is remedied, according to the present invention, by sensing input current Iᵢₙ via a sensor 15 operative to produce on line 16 a signal proportional to input current Iᵢₙ, and closing a feedback loop such as to force input current Iᵢₙ in to follow the desired waveform while, at the same time, keeping the output at the desired power level. This arrangement for controlling the waveform of input current Iᵢₙ as well as controlling the output power level is well known in the art and is widely used in so-called Active Power Factor Correction (APFC) power stages.

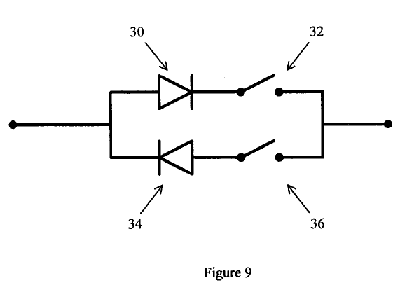

Diode-switch assemblies are not restricted to one particular topology. For example, in FIG. 4, diode-switch assembly 3 takes the form of back-to-back diodes D41 and D42, with each respective diode D41 and D42 in parallel with a corresponding switch S41 and S42. In an alternative topology, illustrated schematically in FIG. 9, diode 30 is in series with switch 32, and diode 34 is in series with switch 36. These two series branches are in parallel with each other such that diode 30 is operative to be conductive in a direction opposite to the direction in which diode 34 is operative to be conductive. The use of diode-switch assemblies of any topology is included within the scope of the present invention.

While the invention has been described with respect to a limited number of embodiments, it will be appreciated that many variations, modifications and other applications of the invention may be made.

What is claimed is:

1. A power converter system connecting an AC power line to a load, comprising:
(a) a series valve in series with the load;
(b) a shunt valve in parallel with the load;
(c) an inductor in series with the load; and
(d) a mechanism for configuring said valves so that the power converter operates as a buck converter while said inductor carries current in phase with the power line and as a boost converter while said inductor carries current out of phase with the power line.

2. The system of claim 1, wherein said mechanism includes:
(i) a control signal,
and wherein said mechanism is operative to operate a said valve according to a duty cycle ratio selected so as to cause a voltage across the load to be substantially in proportion to said control signal.

3. The system of claim 1, wherein said mechanism includes:
(i) a control signal; and
(ii) a feedback sensor,
and wherein said feedback sensor is operative to sense, for use as a feedback signal, a parameter of the system, and wherein said mechanism is operative to compare said feedback signal with said control signal and to operate a said valve according to a duty cycle ratio selected so as to cause said feedback signal to be in proportion to said control signal.

4. The system of claim 3, wherein said feedback signal is selected from the group consisting of an output voltage, an output current, an input current, an inductor current, a load power dissipation, a load temperature, a position, a speed, an acceleration, a force, a torque and a light intensity.

5. The system of claim 1, further comprising:
(e) a mechanism for sensing an output current,
and wherein a said valve is operated according to a duty cycle ratio selected so as to restrict said output current to be within a predetermined limit profile.

6. The system of claim 1, further comprising:
(e) a mechanism for sensing an output current,
and wherein, if said output current exceeds a predetermined limit profile, said valves are operated in a manner selected to interrupt said output current while providing a path for dissipation of a current flowing through said inductor.

7. The system of claim 1, wherein at least one said valve includes a diode-switch assembly.

8. The system of claim 7, wherein at least one said diode-switch assembly includes:
(i) a first diode;
(ii) a second diode;
(iii) a first switch; and
(iv) a second switch,
wherein said first diode is serially connected to said second diode such that said first diode permits flow of current in a direction opposed by said second diode, and wherein said first switch is responsive to a first switch control signal and is connected in parallel with said first diode, and wherein said second switch is responsive to a second switch control signal and is connected in parallel with said first diode.

9. The system of claim 7, wherein at least one said diode-switch assembly includes:
(i) a first diode;
(ii) a second diode;
(iii) a first switch; and
(iv) a second switch,
wherein said first diode is serially connected to said first switch, said first switch being responsive to a first switch control signal, and wherein said second diode is serially connected to said second switch, said second switch being responsive to a second switch control signal, said serially connected said first diode and said first switch being connected in parallel with said serially connected said second diode and said second switch, such that said first diode permits flow of current in a direction opposite to a direction said second diode permits flow of current.

10. The system of claim 1, wherein said mechanism includes:
(i) a sawtooth waveform generator;
(ii) a control signal; and
(iii) a comparator,
wherein said comparator is operative to compare an output of said sawtooth waveform generator with said control signal and to produce an output signal having a duty cycle ratio substantially in proportion to said control signal and operative to control a said valve.

11. The system of claim 1, wherein said mechanism is operative, upon change of polarity of a power line voltage, to operate said valves in a manner that prevents shorting of the power line and provides a conductive path for current in said inductor.

12. The system of claim 1, wherein said mechanism is operative, upon change of polarity of current in said inductor, to operate said valves in a manner that prevents shorting of the power line and provides a conductive path for current in said inductor.

13. The system of claim 1, wherein the system is connected to the power line via a filter.

14. A method of supplying power from an AC power line to a load, comprising the steps of:
(a) connecting a series valve in series with the load;
(b) connecting a shunt valve in parallel with the load;
(c) connecting an inductor in series with the load;
(d) while said inductor carries current in phase with the power line,
configuring said valves to operate as a buck converter; and
(e) while said inductor carries current out of phase with the power line, configuring said valves to operate as a boost converter.
